(19) United States
(12) Patent Application Publication
(10) Pub. No.: US 2024/0403864 A1
(43) Pub. Date: Dec. 5, 2024

(54) BITCOIN HUNTER SYSTEM COMBINED WITH REAL LIFE AUTOMATIC MINING AND HOMOMORPHIC ENCRYPTION BASED DATA ANALYSIS SERVICE MEDIATION

(71) Applicant: Bitcoin Group Co., Ltd., Gwangju (KR)

(72) Inventor: Nam Hyun CHO, Gwangju (KR)

(21) Appl. No.: 18/370,394

(22) Filed: Sep. 19, 2023

(30) Foreign Application Priority Data
Jun. 1, 2023 (KR) 10-2023-0070823

(51) Int. Cl. G06Q 20/36; H04L 9/00

(52) U.S. Cl. CPC G06Q 20/3676; H04L 9/008; G06Q 2220/00

(57) ABSTRACT

The present disclosure relates to a Bitcoin hunter system combined with real-life automatic mining and homomorphic encryption-based data analysis service mediation, and the object of the present disclosure is to combine homomorphic encryption technology and block chain technology to provide necessary analysis services, without leaking sensitive personal information to the outside world, thereby mediating between service requesters and data analysis service providers, and allow service requesters to utilize available or idle computing resources for cryptocurrency mining based on the cloud mining method, enabling cost payment processing as well as resource utilization.

### CROSS-REFERENCE TO RELATED APPLICATION(S)

This application claims priority to Korean Patent Application No. 10-2023-0070823 filed in the Korean Intellectual Property Office on Jun. 1, 2023, the disclosure of which is incorporated by reference herein in its entirety.

### TECHNICAL FIELD

An embodiment of the present disclosure relates to a Bitcoin hunter system combined with real-life automatic mining and homomorphic encryption-based data analysis service mediation and more specifically, a system for combining homomorphic encryption technology and block chain technology to provide necessary analysis services, without leaking sensitive personal information to the outside world, thereby mediating between service requesters and data analysis service providers, and paying service requester's service charge payment funds as computing resources for cryptocurrency mining.

### DISCUSSION OF RELATED ART

Due to technological advances such as biotechnology, artificial intelligence, and fintech, an environment is being created in which personalized analysis services can be received for personal health or economic problems. At the same time, various encryption technologies have been developed to safely store or process sensitive personal information. However, most of the encryption techniques are techniques for safely encrypting/decrypting the original data so that a third party cannot easily decrypt it.

Meanwhile, the homomorphic encryption technology conceived by mathematicians in the 1970s was practically implemented in 2009 by Craig Gentry, a scientist at Stanford University. Homomorphic encryption technology is a technology that embodies the principle of “it's like a box containing gloves used to handle toxic chemicals, and all operations are done inside the box, so the chemicals are never exposed to the outside world,” which is an encryption technology designed to perform calculations directly on encrypted data (cipher text). In other words, it is a technology in which a third-party processes or analyzes encrypted data without viewing the original data as plain text and returns the result to the data owner, and then the data owner decrypts and checks the result.

However, until now, there is no service utilizing such homomorphic encryption technology.

Meanwhile, there are two major methods of mining cryptocurrency (Bitcoin mining method): direct mining and indirect mining. However, the indirect mining method is also called the cloud mining method, and it has the advantage of paying a company that acts as a mining agent and mining using the capabilities of the miner as much as the amount paid and does not require a mining machine or installation site.

### SUMMARY

An embodiment of the present disclosure provides a Bitcoin hunter system combined with real-life automatic mining and homomorphic encryption-based data analysis service mediation for combining homomorphic encryption technology and block chain technology to provide necessary analysis services, without leaking sensitive personal information to the outside world, thereby mediating between service requesters and data analysis service providers, and allowing service requesters to utilize available or idle computing resources for cryptocurrency mining based on the cloud mining method, enabling cost payment processing as well as resource utilization.

The Bitcoin hunter system combined with real-life automatic mining and homomorphic encryption-based data analysis service mediation according to one embodiment of the present disclosure comprises a service requester terminal configured to select an analysis service type and an analysis service provider according to the analysis service type, respectively, provide computing resources for homomorphically encrypted data and cryptocurrency mining respectively, while requesting data analysis, and pay for data analysis costs by utilizing mining revenue through computing resources when receiving data analysis results, a service provider terminal configured to register an available analysis service type, provide an analysis result for the homomorphically encrypted data, and receive payment from the service requestor terminal, and a service mediation server configured to create a smart contract for cryptocurrency mining using mediation and computing resources for data analysis service processing between the service requester terminal and the service provider terminal.

Further, the service requester terminal may comprise an analysis service option selection unit configured to select one analysis service type from among a plurality of analysis service type items and selects one analysis service provider from among a plurality of analysis service providers provided according to the selected analysis service type, a computing resource setting unit configured to set at least one computing resource connectable to the service mediation server for cryptocurrency mining, a cost payment sharing setting unit configured to set the mining revenue using the computing resources of the service requester and the cryptocurrency charged in the electronic wallet as the payment fund for the data analysis cost, but set the payment sharing method for the mining revenue and the cryptocurrency charged in the electronic wallet, and an analysis service management unit configured to generate a private key and the homomorphically encrypted data based on a library environment dedicated to homomorphic encryption provided by the service mediation server and decrypt the received data analysis result with the private key.

Further, the cost payment sharing setting unit may proceed with all payments with cryptocurrency charged in the electronic wallet of the service requestor when the computing resource provided by the service requester terminal is not selected as a cryptocurrency resource.

Further, the cost payment sharing setting unit may set, when the computing resource provided by the service requester terminal is selected as a cryptocurrency resource, the profit generated by cryptocurrency mining as a payment fund first, set, when the difference occurs after payment, the difference to be returned to the electronic wallet and set, when the gap occurs during the payment, the gap amount to be deducted from the electronic wallet.

Further, the service mediation server may comprises a service provider information storage unit configured to store information on analysis service providers by analysis service type, a dedicated application providing unit configured to provide a dedicated application for homomorphic encryption of data to the service requester terminal, an analysis request reception unit configured to provide a list of at least one analysis service provider to the service requestor terminal, receive a data analysis request and homomorphically encrypted data from the service requestor terminal, and transmit the received homomorphically encrypted data to the selected service provider terminal through the service requestor terminal, a smart contract providing unit configured to create and execute a smart contract for requesting analysis of homomorphically encrypted data between the service requester terminal and the service provider terminal, provide analysis results, processing cost payment, paying payment cost, and mining cryptocurrency using computing resources, and a cryptocurrency mining remote control unit configured to perform remote control for cryptocurrency mining based on computing resources provided by the service requester terminal according to the smart contract.

Further, the smart contract providing unit may create the smart contract in which the contract execution conditions including the electronic wallet addresses of the service requester and the service provider, a data analysis cost of the service provider, a payment sharing ratio of the service requester, and the utilization conditions of computing resources for cryptocurrency mining are set to be distributed to a blockchain network, and create a completion signal for the contract execution condition to transmit it as the smart contract, when the service requester terminal receives the data analysis result, and the target value of cryptocurrency mining using the service requestor terminal is achieved, and the service requester terminal and the analysis service provider terminal, respectively, may perform digital signatures on the smart contract.

Further, the homomorphically encrypted data may be data encrypted with somewhat homomorphic encryption (SHE) or data encrypted with fully homomorphic encryption (FHE) based on a lattice encryption algorithm.

Further, the analysis service type may include at least one type of analysis service among medical analysis service, financial analysis service, legal analysis service, and machine learning-based analysis service.

The present disclosure may provide a Bitcoin hunter system combined with real-life automatic mining and homomorphic encryption-based data analysis service mediation for combining homomorphic encryption technology and block chain technology to provide necessary analysis services, without leaking sensitive personal information to the outside world, thereby mediating between service requesters and data analysis service providers, and allowing service requesters to utilize available or idle computing resources for cryptocurrency mining based on the cloud mining method, enabling cost payment processing as well as resource utilization.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a schematic diagram of a Bitcoin hunter system combined with real-life automatic mining and homomorphic encryption-based data analysis service mediation according to an embodiment of the present disclosure;

FIG. 2 is a block diagram showing the configuration of a service requester terminal according to an embodiment of the present disclosure;

FIG. 3 is a block diagram showing the configuration of a service mediation server according to an embodiment of the present disclosure; and

FIG. 4 is a diagram shown to explain the operation process of a Bitcoin hunter system combined with real-life automatic mining and homomorphic encryption-based data analysis service mediation according to an embodiment of the present disclosure.

### DETAILED DESCRIPTION OF EXEMPLARY EMBODIMENTS

The terms used in this specification will be briefly described, and the present disclosure is described in detail.

The terms used in the present disclosure have been selected from general terms that are currently widely used as much as possible while considering the functions in the present disclosure, but these may vary depending on the intention of a person skilled in the art or precedent, the emergence of new technologies, and the like. In a specific case, there is also a term arbitrarily selected by the applicant, and in this case, the meaning will be described in detail in the description of the invention. Therefore, the term used in the present disclosure should be defined based on the meaning of the term and the overall content of the present disclosure, not simply the name of the term.

When it is said that a certain part “includes” a certain component throughout the specification, it means that it may further include other components, not excluding other components unless otherwise stated. Further, terms such as “unit” and “module” described in the specification mean a unit that processes at least one function or operation, which may be implemented as hardware or software or a combination of hardware and software.

Hereinafter, with reference to the accompanying drawings, embodiments of the present disclosure will be described in detail so that those skilled in the art can easily carry out the present disclosure. However, the present disclosure may be embodied in many different forms and is not limited to the embodiments described herein. In order to clearly describe the present disclosure in the drawings, parts irrelevant to the description are excluded, and similar reference numerals are assigned to similar parts throughout the specification.

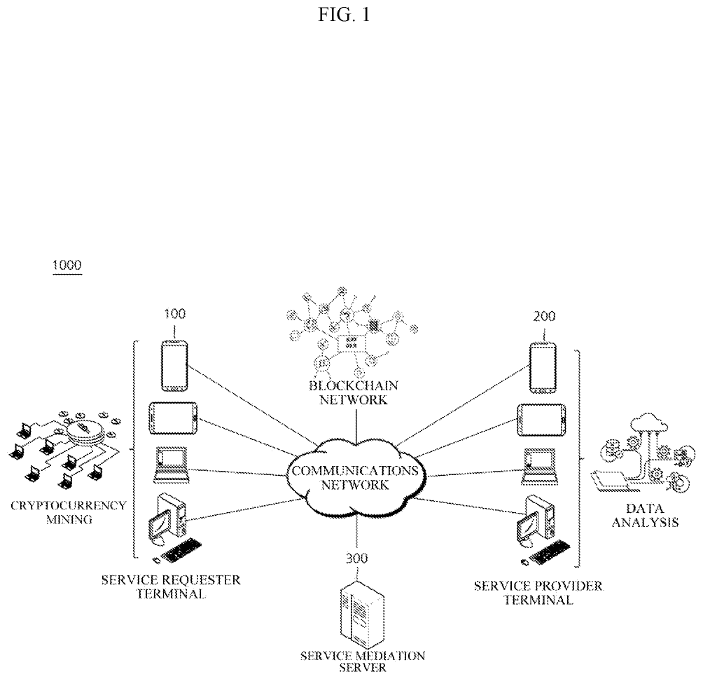

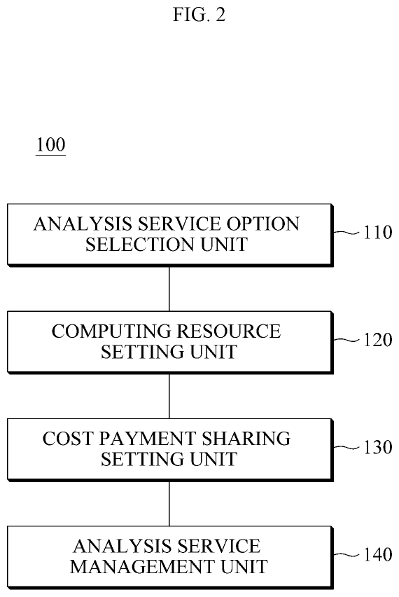

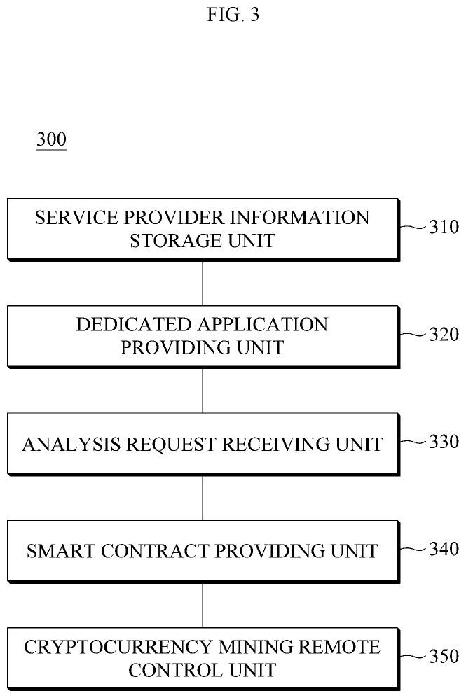

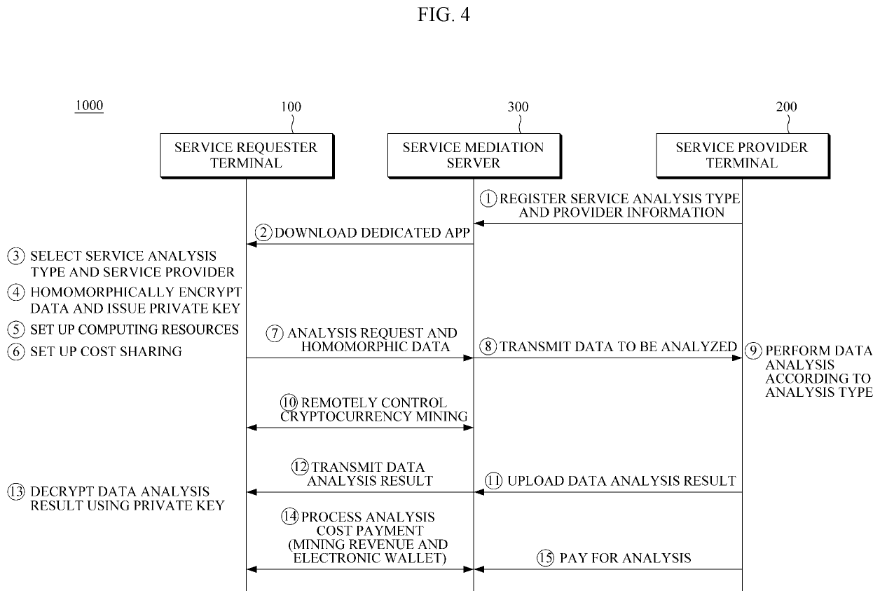

FIG. 1 is a schematic diagram of a Bitcoin hunter system combined with real-life automatic mining and homomorphic encryption-based data analysis service mediation according to an embodiment of the present disclosure. FIG. 2 is a block diagram showing the configuration of a service requester terminal according to an embodiment of the present disclosure. FIG. 3 is a block diagram showing the configuration of a service mediation server according to an embodiment of the present disclosure. FIG. 4 is a diagram shown to explain the operation process of a Bitcoin hunter system combined with real-life automatic mining and homomorphic encryption-based data analysis service mediation according to an embodiment of the present disclosure.

Referring to FIG. 1, the Bitcoin hunter system combined with real-life automatic mining and homomorphic encryption-based data analysis service mediation 1000 according to an embodiment of the present disclosure comprises at least one service requester terminal 100, at least one service provider terminal 200, and at least one service mediation server 300.

The service requester terminal 100 may select an analysis service type and an analysis service provider provided according to the analysis service type, request data analysis to the service mediation server 300 while providing computing resources for homomorphically encrypted data and cryptocurrency mining, respectively, and utilize, when the data analysis result is received from the service mediation server 300, the mining revenue generated through the computing resources provided by the service requestor to pay the corresponding data analysis cost.

To this end, as shown in FIG. 2, the service requester terminal 100 may comprise at least one of an analysis service option selection unit 110, a computing resource setting unit 120, a cost payment sharing setting unit 130, and an analysis service management unit 140.

The analysis service option selection unit 110 may select one analysis service type from among a plurality of analysis service type items and select one analysis service provider from among a plurality of analysis service providers provided according to the selected analysis service type.

For example, the analysis service type may include at least one type of analysis service among medical analysis service, financial analysis service, legal analysis service, and machine learning-based analysis service, and the service requester may select any one of the corresponding types. When an analysis service type is selected, information on service providers capable of providing analysis services for the corresponding type is provided as a list, and analysis service option selection can be completed by selecting one service provider from the list.

The computing resource setting unit 120 may set at least one computing resource connectable to the service mediation server 300 for cryptocurrency mining.

For example, the service requester can set the currently connected service requester terminal 100 as a computing resource for cryptocurrency mining, as well as information on computer devices available to the service requestor or in an idle state (computer information necessary for remote control of the device) is additionally set, so that after the smart contract is created, it is connected to the set computer device, thereby allowing cryptocurrency mining using the corresponding resources.

The computing resources configured in this way operate as one node, and at this time, the node may refer to a node constituting a cloud platform connected via the service requester terminal 100 and the service mediation server 300 using a web page, app page, program, or dedicated application related to cloud-based virtual currency mining service.

Mining cryptocurrency by using the computing resources provided by the service requester means that it is assumed that the service mediation server 300 has been granted access rights to use mining networking resources, computing resources, and electrical energy by accessing the corresponding computing resources, and in the case of Bitcoin, even if mining is attempted, not all nodes attempting to mine will obtain Bitcoin, so giving them the opportunity to try mining does not guarantee that all of them will obtain a cryptocurrency such as Bitcoin.

The cost payment sharing setting unit 130 may set the mining revenue (Cryptocurrency itself or the sale amount of mined cryptocurrency) using the service requester's computing resources and the cryptocurrency charged in the electronic wallet as payment funds for the data analysis cost but set the payment sharing method for the mining revenue and the cryptocurrency charged in the electronic wallet.

Further, more specifically, the cost payment sharing setting unit 130 may proceed with all payments with cryptocurrency charged in the electronic wallet of the service requestor when the computing resource provided by the service requester terminal 100 is not selected as a cryptocurrency resource.

For example, in order for cryptocurrency mining using the computing resources set by the service requester, the corresponding computer resources must have hash power or mining power, but when the service mediation server 300 determines that the corresponding computing resource is not suitable for mining as a result of analyzing the specifications of the corresponding computing resource, the devices set by the service requestor cannot be registered as mining means. In this case, since the cost of requesting service analysis has not been resolved through the provision of computing resources for mining cryptocurrency, the service requestor is set to pay the corresponding cost through its own electronic wallet.

Further, the cost payment sharing setting unit 130 may, when the computing resource provided by the service requester terminal 100 is selected as a cryptocurrency resource, set the profit generated by cryptocurrency mining as a payment fund first, set, when the difference occurs after payment, the difference to be returned to the electronic wallet and set, when the gap occurs during the payment, the gap amount to be deducted from the electronic wallet.

In other words, in principle, the revenue generated from cryptocurrency mining is to be used first for the cost of the analysis service. If a difference occurs when payment is made with mining revenue, the difference can be set to be returned to the electronic wallet of the service requester. Conversely, if some amount is insufficient when payment is made with mining revenue, the amount of the deficiency can be set to be deducted from the service requester's electronic wallet.

The analysis service management unit 140 may generate a private key and homomorphically encrypted data based on a library environment dedicated to homomorphic encryption provided by the service mediation server 300 and decrypt the received data analysis result with the private key.

When the analysis service management unit 140 executes a dedicated application to perform homomorphic encryption on personal data, a private key is issued and homomorphic encryption on the data is performed using the private key, and the homomorphically encrypted data and the private key may be stored in the service requester terminal 100. That is, the service requester terminal 100 may perform homomorphic encryption on the data with the private key issued through the dedicated application and decrypt the received analysis result with the private key. Here, the analysis result means processed data generated by the service provider terminal 200 performing an analysis service on homomorphically encrypted data. The processed data, that is, the analysis result is decrypted with the private key in the service requester terminal 100 and can be checked by the user.

The analysis service management unit 140 may receive at least one analysis service provider from the service mediation server 300. To this end, the service requester terminal 100 may download and install the dedicated application provided by the service mediation server 300. The service requester terminal 100 may execute the dedicated application, receive a list of analysis service providers and types of analysis services that can be provided, and show the list on a display. When a user selects a specific analysis service provider, he or she can check detailed information about the analysis service provided by that analysis service provider, and detailed information on such an analysis service may include analysis cost, service execution period, analysis item, cryptocurrency wallet address for payment processing, and the like.

When the service requestor selects a desired analysis service provider and transmits an analysis request, the analysis service management unit 140 may perform homomorphic encryption on the data of the service requester who wants to receive analysis service. That is, when performing homomorphic encryption on the data of the analysis target through a dedicated application, a private key is issued, and homomorphic encryption of the to-be-analyzed data is performed using the issued private key, and the homomorphically encrypted data and the corresponding private key may be stored through the analysis service management unit 140.

The analysis service management unit 140 may upload homomorphically encrypted data together to the service mediation server 300 when requesting data analysis to an analysis service provider selected by the service requester.

Here, the to-be-analyzed data means the data that the user wants to receive the analysis service, and for example, it may include personal sensitive information such as user's genetic information, medical information, financial information, shopping information, education information, and photo information.

Here, the analysis request may include the analysis service provider selected by the service requestor and the type of analysis service, the service requester's cryptocurrency wallet address for payment, cost payment sharing setting information, information related to computing resources for cryptocurrency mining, etc.

The dedicated application for homomorphic encryption according to the present embodiment may be equipped with a homomorphic encryption library for supporting homomorphic encryption of data of an individual that a service requester wants to receive an analysis service. Examples of libraries that support such homomorphic encryption include the Microsoft SEAL library for supporting BFV and approximate homomorphic encryption (CKKS) schemes, MIT's PALISADE library for supporting homomorphic encryption schemes such as BGV, BFV, CKKS, TFHE, and FHEW, IBM's HElib library, which supports CKKS and BGV, HeaAn library for implementing the CKKS scheme supporting fixed-point approximation arithmetic, Haskell library for ring-based lattice encryption, cuHE and CUFHE libraries, which are high-speed libraries for homomorphic encryption through GPU developed by WPI, NFLlib library developed by Sorbonne in Europe, TFHE library, a TFHE scheme support library developed by KU Leuven, and Lattigo, a multi-user library developed by EPFL.

Homomorphical encrypted data according to this embodiment may be encrypted based on a lattice encryption algorithm. The Bitcoin Hunter system 1000 according to an embodiment of the present disclosure can support the above-described various homomorphic encryption libraries to generate homomorphically encrypted data using any one lattice encryption algorithm of the NTRU, SS-NTRU, BLISS, New Hope, NTRU Prime, and LWE-Frodo. Homomorphically encrypted data may be data encrypted with somewhat homomorphic encryption (SHE) based on a lattice encryption algorithm. Homomorphically encrypted data may be data encrypted with fully homomorphic encryption (FHE) based on a lattice encryption algorithm.

There are three types of homomorphic encryption: partially homomorphic encryption (PHE), somewhat homomorphic encryption (SHE), and fully homomorphic encryption (FHE). Partially homomorphic encryption (PHE) allows only one type of mathematical operation for an unlimited amount of time on a given data set. Somewhat homomorphic encryption (SHE) is more permissive than partial homomorphic encryption (PHE), but still restrictive, allowing only a few additions and multiplications for a given data set. Fully homomorphic encryption (FHE) allows various types of operations on a data set without limit. Therefore, somewhat homomorphic encryption (SHE) or full homomorphic encryption (FHE) can be applied depending on the type of analysis service.

The analysis service management unit 140 may perform an electronic signature on a smart contract distributed in a blockchain network. Regardless of the order, the service requester terminal 100 or the service provider terminal 200 may perform a digital signature on the distributed smart contract, and the smart contract may be created as a multi-signature wallet and may be configured to enable digital signatures of both parties or third parties involved in the service mediation server 300.

After performing the digital signature, the analysis service management unit 140 may receive an analysis result for the homomorphically encrypted data from the service provider terminal 200. The service requester terminal 100 may decrypt the analysis result using the private key provided by the dedicated application. Through this, the service requester can check the decrypted analysis result to identify the analysis result for the data he/she wants.

When receiving the analysis result from the service mediation server 300, the analysis service management unit 140 may generate a contract execution condition completion signal and transmit it as the smart contract. When the smart contract receives the contract execution condition completion signal, the service requester terminal 100 performs the electronic signature on the smart contract while pre-deposited cryptocurrency corresponding to the value of the analysis cost and/or the revenue generated by cryptocurrency mining is transmitted to the cryptocurrency wallet address of the service provider terminal 200 and paying the cost, thereby completing the contract.

The service requester terminal 100 includes wireless communication devices that service requesters can carry, such as a smartphone, a smart pad, a tablet PC, a personal communication system (PCS), a global system for mobile communications (GSM), a personal digital cellular (PDC), personal handyphone system (PHS), personal digital assistant (PDA), international mobile telecommunication (IMT)-2000, code division multiple access (CDMA)-2000, W-code division multiple access (W-CDMA), and wireless broadband internet (Wibro), and portable computing devices such as a stationary PC and a laptop.

The service provider terminal 200 registers the available types of analysis service by the service provider in the service mediation server 300, provide an analysis result for the homomorphically encrypted data and receive payment paid by the service requester terminal 100 through the electronic wallet of the service provider.

The service provider terminal 200 may register the available types of analysis services in the service mediation server 300. Further, the service provider terminal 200 may additionally provide information related to the analysis service, such as analysis cost, service execution period, analysis item, and cryptocurrency wallet address for payment processing, to the service mediation server 300.

The service provider terminal 200 may perform an analysis service by receiving homomorphically encrypted data from the service mediation server 300. To this end, the service provider terminal 200 may be a computing device capable of processing and performing data at a level capable of analyzing data for service provision. That is, the service provider terminal 200 may be configured to enable operations on homomorphically encrypted data.

The service provider terminal 200 may perform a digital signature on the smart contract distributed by the service mediation server 300. Regardless of the order, the service requester terminal 100 or the service provider terminal 200 may perform a digital signature on the distributed smart contract, and the smart contract may be created as a multi-signature wallet and may be configured to enable digital signatures of both parties or third parties involved in the service mediation server 300.

The blockchain network according to this embodiment may be a public blockchain network such as a blockchain, Ethereum, etc. capable of distributing and executing smart contracts, or a private blockchain network such as an open source based Hyperledger fabric for enterprises.

The service provider terminal 200 includes wireless communication devices that service requesters can carry, such as a smartphone, a smart pad, a tablet PC, a personal communication system (PCS), a global system for mobile communications (GSM), a personal digital cellular (PDC), personal handyphone system (PHS), personal digital assistant (PDA), international mobile telecommunication (IMT)-2000, code division multiple access (CDMA)-2000, W-code division multiple access (W-CDMA), and wireless broadband internet (Wibro), and portable computing devices such as a stationary PC and a laptop.

The service mediation server 300 creates a smart contract for cryptocurrency mining using mediation and computing resources for data analysis service processing between the service requester terminal 100 and the service provider terminal 200, implement the created smart contract, communicates with the service requester terminal 100, the service provider terminal 200, and the blockchain network to exchange information or data with each other, thereby remotely accessing a data analysis service mediation task and a computing resource provided by a service requestor to perform a control operation for cryptocurrency mining.

To this end, as shown in FIG. 3, the service mediation server 300 may include at least one of a service provider information storage unit 310, a dedicated application providing unit 320, an analysis request receiving unit 330, a smart contract providing unit 340, and a cryptocurrency mining remote control unit 350,

The service provider information storage unit 310 is configured to additionally store and provide information on analysis service providers by type of analysis service and information on the analysis service, such as analysis cost, service execution period, analysis item, cryptocurrency wallet address for payment processing, etc.

For example, the analysis service type may include at least one type of analysis service among medical analysis service, financial analysis service, legal analysis service, and machine learning-based analysis service, and the service provider may set available service types among corresponding types and register profile information (history, career, a field of expertise, etc.) related to service analysis.

The dedicated application providing unit 320 may provide a dedicated application for homomorphic encryption of data to the service requester terminal 100.

The dedicated application for homomorphic encryption according to the present embodiment may be provided to the service requester terminal 100 and may equip with a homomorphic encryption library for supporting homomorphic encryption of data of an individual that a user wants to receive an analysis service. Examples of libraries that support such homomorphic encryption include the Microsoft SEAL library for supporting, BFV and approximate homomorphic encryption (CKKS) schemes, MIT's PALISADE library for supporting homomorphic encryption schemes such as BGV, BFV, CKKS, TFHE, and FHEW, IBM's HElib library, which supports CKKS and BGV, HeaAn library for implementing the CKKS scheme supporting fixed-point approximation arithmetic, Haskell library for ring-based lattice encryption, cuHE and CUFHE libraries, which are high-speed libraries for homomorphic encryption through GPU developed by WPI, NFLlib library developed by Sorbonne in Europe, TFHE library, a TFHE scheme support library developed by KU Leuven, and Lattigo, a multi-user library developed by EPFL.

The analysis request reception unit 330 may provide a list of at least one analysis service provider to the service requester terminal 100, receive a data analysis request and homomorphically encrypted data from the service request terminal 100, and transmit the received homomorphically encrypted data to the selected service provider terminal 200 through the service requester terminal 100.

More specifically, the analysis request receiving unit 330 may receive a service type to be provided among various types such as medical analysis service, financial analysis service, legal analysis service, and machine learning-based analysis service, selection information of any one of the service providers registered for the service type, and homomorphically encrypted data from the service requester terminal 100. When such an analysis request is received from the service requester terminal 100, homomorphically encrypted data may be provided to the corresponding service provider terminal 200 to request data analysis.

The smart contract providing unit 340 may create a smart contract for requesting analysis of homomorphically encrypted data between the service requester terminal 100 and the service provider terminal 200, providing analysis results, processing cost payment, paying payment cost, and mining cryptocurrency using computing resources, and deploy the created smart contract on the blockchain network.

More specifically, the smart contract providing unit 340 may create a smart contract for service mediation between the service requester terminal 100 and the selected service provider terminal 200 and cryptocurrency mining based on contract execution conditions including electronic wallet addresses of the service requester and service provider, data analysis cost of the service provider, payment sharing ratio of the service requestor, and utilization conditions of computing resources for cryptocurrency mining At this time, the smart contract may be created as a multi-signature wallet. Here, the contract execution condition may mean that the analysis result generated by performing the analysis service by the service provider terminal 200 is provided to the service requestor terminal 100, a preset cost payment is processed according to the provision of the analysis result, and cryptocurrency is mined using computing resources provided by the service requester terminal 100. When the service requestor terminal 100 receives the analysis result, a contract execution condition completion signal may be generated and transmitted to the smart contract. Here, the blockchain network may be a public blockchain network such as a blockchain, Ethereum, etc. capable of distributing and executing smart contracts, or a private blockchain network such as an open source based Hyperledger fabric for enterprises.

When the service requester terminal 100 receives the data analysis result and the target value of cryptocurrency mining using the service requestor terminal 100 is achieved, the smart contract providing unit 340 may generate a contract execution condition completion signal and transmit it to the smart contract, and at this time, the service requester terminal 100 and the analysis service provider terminal 200 may each perform a digital signature on the smart contract.

Meanwhile, the smart contract providing unit 340 may create a smart contract and request an audit of the smart contract in conjunction with an external smart contract audit agency server before distributing the smart contract to the blockchain network. When the specified conditions are executed, the smart contract is irreversibly executed. Therefore, if there is a problem with the code stored on the smart contract or a logical error, it is difficult to reverse, so it can be audited for potential problems or vulnerabilities on smart contracts in connection with an authorized external smart contract audit agency server. If an external smart contract audit agency server audits the smart contract and finds problems, problems and proposed solutions may be transmitted to the smart contract providing unit 340. When receiving the problem of the smart contract and the proposed solution, the smart contract providing unit 340 may modify the smart contract based on the proposed solution and distribute it to the blockchain network.

The cryptocurrency mining remote controller 350 is based on the computing resources provided by the service requester terminal 100 according to the smart contract, that is, the service mediation server 300 or other computer devices can remotely access the service requester terminal 100 or/and other computing resources set by the service requestor, and then control the resources to perform operations for cryptocurrency mining.

Meanwhile, mining in Bitcoin is a proof of work process that finds partial hash collisions, and only the miner who first mined has the right to add the created block to the blockchain. The computational ability to find partial hash collisions is called hash power or mining power. The greater the hash power used in mining, the faster the mining time. Since Bitcoin mining started in 2009, the hash power used for mining has been continuously increasing. The creation of a block has an important meaning in the Bitcoin system. Each block has multiple financial transaction information, and only when this block is created smoothly may complete a transaction using Bitcoin. Since these blocks are created only through the mining process, the hash power input for mining affects the block creation time. In Bitcoin, it is designed to create one block every 10 minutes, and the concept of mining difficulty is used to cope with the volatility of hash power. In other words, if the average block creation time is less than 10 minutes after 2016 blocks are created, it is considered that the hash power has increased, and the mining difficulty can be adjusted by increasing the mining difficulty by proportion.

The service mediation server 300 may have the same configuration as a typical web server in terms of hardware and include program modules that perform various functions by implementing through various types of languages such as C, C++, Java, Visual Basic, Visual C, etc. in terms of software. Further, general server hardware may be implemented using a web server program that is provided in various ways according to an operating system such as iOS, DOS, Windows, Linux, Unix, Macintosh, and Android,

An example of network communication connecting the service requester terminal 100, the service provider terminal 200, the service mediation server 300, and the blockchain network according to this embodiment may include, but is not particularly limited to, a mobile communication network (for example, global system for mobile communication (GSM), code division multi access (CDMA), code division multi access 2000 (CDMA2000), Enhanced Voice-Data Optimized or Enhanced Voice-Data Only (EV-DO), wideband CDMA (WCDMA), high speed downlink packet access (HSDPA), high speed uplink packet access (HSUPA), long term evolution (LTE), long term evolution-advanced (LTE-A), 5G, etc.) established according to technical standards or communication methods for mobile communication. Further, an example of a wired communication network may be a closed network such as a local area network (LAN) and a wide area network (WAN), preferably an open network such as the Internet. The Internet refers to a worldwide open computer network structure that provides various services existing in the TCP/IP protocol and its upper layers, that is, hypertext transfer protocol (HTTP), telnet, file transfer protocol (FTP), domain name system (DNS), simple mail transfer protocol (SMTP), simple network management protocol (SNMP), network file service (NFS), and network information service (NIS).

The above description is only for one embodiment for implementing the Bitcoin hunter system combined with real-life automatic mining and homomorphic encryption-based data analysis service mediation according to the present disclosure. The present disclosure is not limited to the above embodiment. As claimed in the claims below, it is understood that the technical spirit of the present disclosure exists to the extent that various changes can be made by those skilled in the art without departing from the gist of the present disclosure.

What is claimed is:

1. A Bitcoin hunter system combined with real-life automatic mining and homomorphic encryption-based data analysis service mediation, the system comprising:
a service requester terminal configured to select an analysis service type and an analysis service provider according to the analysis service type, respectively, provide computing resources for homomorphically encrypted data and cryptocurrency mining respectively, while requesting data analysis, and pay for data analysis costs by utilizing mining revenue through computing resources when receiving data an analysis result;
a service provider terminal configured to register an available analysis service type, provide the analysis result for the homomorphically encrypted data and receive payment from the service requestor terminal; and
a service mediation server configured to create a smart contract for cryptocurrency mining using mediation and computing resources for data analysis service processing between the service requester terminal and the service provider terminal.

2. The Bitcoin hunter system of claim 1, wherein the service requester terminal comprises:
an analysis service option selection unit configured to select one analysis service type from among a plurality of analysis service type items and select one analysis service provider from among a plurality of analysis service providers provided according to the selected analysis service type;
a computing resource setting unit configured to set at least one computing resource connectable to the service mediation server for cryptocurrency mining;
a cost payment sharing setting unit configured to set the mining revenue using the computing resources of the service requester and the cryptocurrency charged in the electronic wallet as the payment fund for the data analysis cost, but set the payment sharing method for the mining revenue and the cryptocurrency charged in the electronic wallet; and
an analysis service management unit configured to generate a private key and the homomorphically encrypted data based on a library environment dedicated to homomorphic encryption provided by the service mediation server and decrypt the received data analysis result with the private key.

3. The Bitcoin hunter system of claim 2, wherein the cost payment sharing setting unit proceeds with all payments with cryptocurrency charged in the electronic wallet of the service requestor, when the computing resource provided by the service requester terminal is not selected as a cryptocurrency resource.

4. The Bitcoin hunter system of claim 2, wherein the cost payment sharing setting unit sets, when the computing resource provided by the service requester terminal is selected as a cryptocurrency resource, the profit generated by cryptocurrency mining as a payment fund first, sets, when the difference occurs after payment, the difference to be returned to the electronic wallet, and sets, when the gap occurs during the payment, the gap amount to be deducted from the electronic wallet.

5. The Bitcoin hunter system of claim 2, wherein the service mediation server comprises:
a service provider information storage unit configured to store information on an analysis service provider by analysis service type;
a dedicated application providing unit configured to provide a dedicated application for homomorphic encryption of data to the service requester terminal;
an analysis request reception unit configured to provide a list of at least one analysis service provider to the service requestor terminal, receive a data analysis request and homomorphically encrypted data from the service requestor terminal, and transmit the received homomorphically encrypted data to the selected service provider terminal through the service requestor terminal;
a smart contract providing unit configured to create and execute a smart contract for requesting analysis of homomorphically encrypted data between the service requester terminal and the service provider terminal, provide analysis results, processing cost payment, paying payment cost, and mining cryptocurrency using computing resources; and
a cryptocurrency mining remote control unit configured to perform remote control for cryptocurrency mining based on computing resources provided by the service requester terminal according to the smart contract.

6. The Bitcoin hunter system of claim 5, wherein the smart contract providing unit creates the smart contract in which a contract execution condition including the electronic wallet addresses of the service requester and the service provider, a data analysis cost of the service provider, a payment sharing ratio of the service requester, and the utilization conditions of computing resources for cryptocurrency mining are set to be distributed to a blockchain network, and creates a completion signal for the contract execution condition to transmit it as the smart contract, when the service requester terminal receives the data analysis result, and the target value of cryptocurrency mining using the service requestor terminal is achieved, and the service requester terminal and the analysis service provider terminal, respectively, perform digital signatures on the smart contract.

7. The Bitcoin hunter system of claim 1, wherein the homomorphically encrypted data is data encrypted with somewhat homomorphic encryption (SHE) or data encrypted with fully homomorphic encryption (FHE) based on a lattice encryption algorithm.

8. The Bitcoin hunter system of claim 1, wherein the analysis service type includes at least one type of analysis service among medical analysis service, financial analysis service, legal analysis service, and machine learning-based analysis service.
